(19) United States
(12) Patent Application Publication
(10) Pub. No.: US 2026/0366662 A1
(43) Pub. Date: Nov. 19, 2026

(54) REPLACEABLE JOINT WITH BIDIRECTIONAL INTERLOCKING FUNCTION

(71) Applicant: LUXECASTING MACHINERY CO., LTD, YICHUN (CN)

(72) Inventors: FANGQIANG LU, YICHUN (CN); YUCHENG ZHANG, YICHUN (CN); JIANBAO HU, YICHUN (CN); HERONG YAN, YICHUN (CN); WEI ZHOU, YICHUN (CN)

(21) Appl. No.: 19/531,693

(22) Filed: Feb. 6, 2026

(30) Foreign Application Priority Data
May 19, 2025 (CN) 202510641398.5

(51) Int. Cl. F16L 37/47; F16L 37/252

(52) U.S. Cl. CPC F16L 37/47; F16L 37/252

(57) ABSTRACT

A replaceable joint with a bidirectional interlocking function comprises a joint body, a rotating valve, and a movable latch. Protrusions and grooves are disposed on a docking end of the joint body. When the replaceable joint is locked with an identical replaceable joint, a matched protrusion of the identical replaceable joint rotates and presses against a ramp. The ramp moves upward, a protruding pin moves into an inclined track, and a locking hook rotates downward. At this point, the locking hook does not interfere with a circumferential rotation path of the matched protrusion, allowing the two replacement joints to continue rotating and unscrewing in a circumferential direction. When the handle is rotated to drive the valve core to rotate and open, the protruding pin is pushed into a straight track, and the locking hook hooks onto the matched protrusion, limiting a circumferential rotation of the identical replaceable joint.

### TECHNICAL FIELD

The present disclosure relates to a technical field of pipe connections, and in particular to a replaceable joint with a bidirectional interlocking function.

### BACKGROUND

A rapid joint achieves rapid pipeline connection through rotational locking, but a structure of a conventional rapid joint only relies on locking frictional resistance of the rapid joint and lacks a circumferential limiting structure.

When the pipeline experiences vibration, pressure fluctuations, or unexpected torsional forces, the rapid joint is prone to rotating, leading to gradual loosening of the rapid joint and resulting in low reliability and stability.

### SUMMARY

In view of defects in the prior art, the present disclosure provides a replaceable joint with a bidirectional interlocking function. The replaceable joint comprises a joint body, a rotating valve, and a movable latch. Protrusions and grooves are disposed on a docking end of the joint body. When the replaceable joint is docked with an identical replaceable joint, the protrusions of the replaceable joint are respectively screwed into grooves of the identical replaceable joint, and the grooves of the replaceable joint are respectively engaged with protrusions of the identical replaceable joint, so that the replaceable joint is locked with the identical replaceable joint. The rotating valve is disposed on the joint body. A handle of the rotating valve is disposed on an outer side of the joint body. The handle is rotated to close or open the rotating valve. The movable latch is rotatably disposed in one of the grooves close to the rotating valve to form a lever structure, and the rotating valve is matched with the movable latch. When the rotating valve is in an open state, the movable latch is disposed in the one of the grooves and is engaged with a matched protrusion of the protrusions of the identical replaceable joint to limit a rotation of the matched protrusion in a circumferential direction. When the rotating valve is in a closed state, the movable latch is disengaged with the matched protrusion.

Furthermore, a lock hook is disposed on a first end of the movable latch, a protruding pin is disposed on a second end of the movable latch, and a middle portion of the movable latch is rotatably connected to the joint body. A sliding track is disposed on the handle of the rotating valve, and the sliding track comprises an inclined track and a straight track. In an initial state, the protruding pin is positioned on the inclined track. When the handle is rotated to open the rotating valve, the protruding pin is pressed by the inclined track to cause the locking hook of the movable latch to be engaged with the protruding block.

Furthermore, the movable latch further comprises a ramp. The ramp is in press fit with the matched protrusion. The sliding track further comprises a blocking track, the blocking track is communicated with the inclined track. The inclined track is straight and inclined. In the initial state, the protruding pin is positioned at the blocking track. When the matched protrusion of the identical replaceable joint is screwed into a corresponding one of the grooves of the replaceable joint, the matched protrusion pushes the inclined track to move the protruding pin to the inclined track. The replaceable joint further comprises a torsion spring disposed between the movable latch and the joint body.

Furthermore, the joint body comprises a valve body, a tail portion rotatably connected to the valve body. A threaded port configured to connect to a pipeline is disposed on the tail portion. The rotating valve and the movable latch are disposed on the valve body. The protrusions and the groove are disposed on one side of the valve body away from the tail portion.

Furthermore, a steel ball is disposed between the tail portion and the valve body, and the valve body is rotatably connected to the tail portion through the steel ball.

Furthermore, a fifth sealing ring and a second guiding strap are further provided between the tail portion and the valve body.

Furthermore, the rotating valve comprises a valve core rotatably disposed inside the joint body. The handle is fixedly connected to the valve core. The valve core is controlled by rotating the handle to close or open the pipeline.

Furthermore, the handle and the valve core are fixedly connected by a valve rod. A first sealing ring is disposed between an outer wall of the valve rod and the valve body. A first guiding strap is disposed between the outer wall of the valve rod and the valve body. The rotating valve further comprises a fixing pin disposed on the valve body. The valve core is rotatably connected to the fixing pin. A fourth sealing ring is provided between the fixing pin and the valve body.

Furthermore, a second sealing ring is disposed on the docking end of the joint body. When the replaceable joint is docked with the identical replaceable joint, the second sealing ring of the replaceable joint and a second sealing ring of the identical replaceable joint are pressed against and attached to each other.

Furthermore, a third sealing ring is disposed on the valve body, and the third sealing ring is attached to a surface of the valve core.

When the replaceable joint is docked and rotationally locked with the identical replaceable joint, the matched protrusion of the identical replaceable joint rotates and presses against the ramp, causing the ramp to rotate and move upward. Simultaneously, the protruding pin rotates and moves upward into the inclined track, while the locking hook rotates and moves downward. At this point, the locking hook does not interfere with a circumferential rotation path of the protrusions of the identical replaceable joint. The replaceable joint is allowed to rotate to be unscrewed from the identical replaceable joint. When the handle rotates to open the valve core, the inclined track drives the protruding pin to move upward and rotate into the straight track. Meanwhile, the locking hook is engaged with the matched protrusion of the identical replaceable joint, restricting a circumferential rotation of the replaceable joint. The movable latch is circumferentially engaged with the matched protrusion of the identical replaceable joint, thereby effectively limiting the circumferential rotation of the replaceable joint and the identical replaceable joint and preventing the replaceable joint and the identical replaceable joint from loosening.

Furthermore, when the replaceable joint is not docked with the identical replaceable joint, the handle is unable to be driven because the protruding pin is blocked by the blocking track, keeping the valve core in a closed state. When the replaceable joint is docked and rotationally locked with the identical replaceable joint, the matched protrusion of the identical replaceable joint rotates and compresses the ramp, causing the protruding pin to move from the blocking track into the inclined track. At this point, the valve core is opened by rotating the handle. Thus, the valve core is only able to be opened after the replaceable joint is docked with the identical replaceable joint, achieving an anti-misoperation function.

### BRIEF DESCRIPTION OF DRAWINGS

FIG. 1 is a perspective schematic diagram of a replaceable joint according to one embodiment of the present disclosure.

FIG. 2 is a cross-sectional schematic diagram of the replaceable joint according to one embodiment of the present disclosure.

FIG. 3 is a perspective schematic diagram of a lever limiting mechanism according to one embodiment of the present disclosure.

FIG. 4 is a perspective schematic diagram of a handle according to one embodiment of the present disclosure.

FIG. 5 is a partial perspective schematic diagram of two replaceable joints according to one embodiment of the present disclosure, where the two replaceable joints are to be docked with each other.

FIG. 6 is a partial cross-sectional schematic diagram of the two replaceable joints according to one embodiment of the present disclosure, where the two replaceable joints are to be docked with each other.

FIG. 7 is a partial perspective schematic diagram of the two replaceable joints docked with each other, where the handle is in a closed state.

FIG. 8 is a partial cross-sectional schematic diagram of the two replaceable joints docked with each other, where the handle is in the closed state.

FIG. 9 is a partial perspective schematic diagram of the two replaceable joints docked with each other, where the handle is in an open state.

FIG. 10 is a partial cross-sectional schematic diagram of the two replaceable joints docked with each other, where the handle is in the open state.

FIG. 11 is an exploded schematic diagram of the replaceable joint according to one embodiment of the present disclosure.

FIG. 12 is a schematic diagram of the replaceable joint according to one embodiment of the present disclosure, where a movable latch is disposed in one of the grooves.

In the drawings: 1—tail portion, 2—valve body, 3—valve core, 4—valve rod, 5—handle, 6—movable latch, 7—fixing screw, 8—first guide strap, 9—first sealing ring, 10—first screw, 11—protrusion, 12—second sealing ring, 13—third sealing ring, 14—fixing pin, 15—protective sleeve, 16—fourth sealing ring, 17—second guide strap, 18—fifth sealing ring, 19—steel ball, 20—groove, 21—locking hook, 22—second screw, 23—protruding pin, 24—ramp, 25—torsion spring, 26—blocking track, 27—inclined track, 28—straight track.

### DETAILED DESCRIPTION

For ease of understanding, the present disclosure is described fully hereinafter with reference to the accompanying drawings. Several embodiments of the present disclosure are given in the accompanying drawings. However, the present disclosure may be implemented in many different forms and is not limited to the embodiments described herein. On the contrary, a purpose of providing these embodiments is to make the disclosure of the present disclosure more thorough and comprehensive.

It should be noted that when an element is referred to as being “fixed to” another element, it may be directly fixed to another element or indirectly fixed to another element through intervening elements. When the element is considered to be “connected” to another element, it may be directly connected to another element or intervening elements may be present at the same time. The terms “vertical”, “horizontal”, “left”, “right”, and the like, as used herein, are for illustrative purposes only.

Unless otherwise defined, all technical and scientific terms used herein have the same meaning as commonly understood by those skilled in the art of the present disclosure. The terms used in the specification of the present disclosure are only for the purpose of describing specific embodiments, and are not intended to limit the present disclosure. As used herein, the term “and/or” comprises all combinations including one or more of the associated listed items.

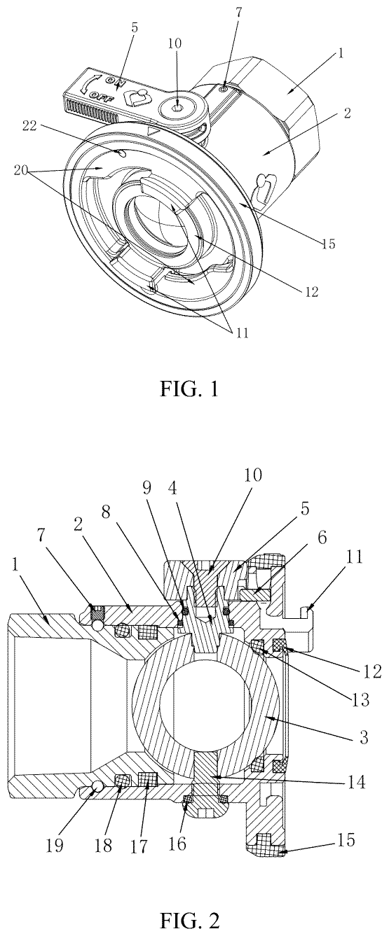

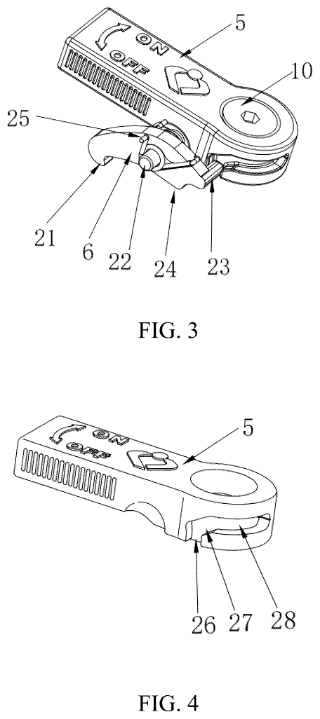

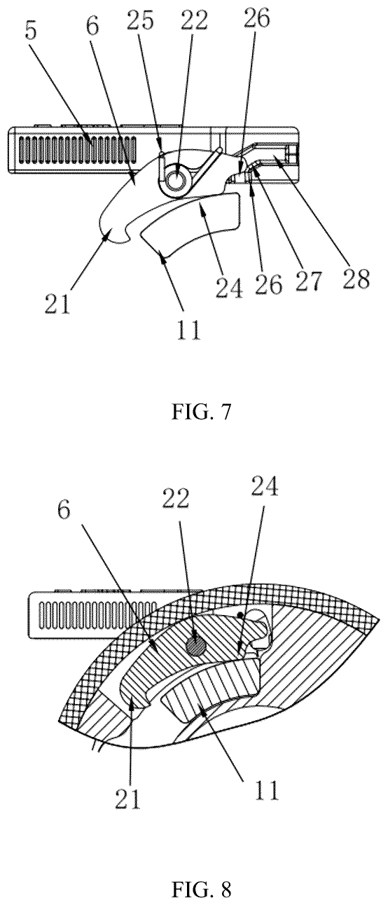

As shown in FIGS. 1-12, the present disclosure provides a replaceable joint with a bidirectional interlocking function. The replaceable joint comprises a joint body, a rotating valve, and a movable latch 6. The joint body comprises a tail portion 1 and a valve body 2.

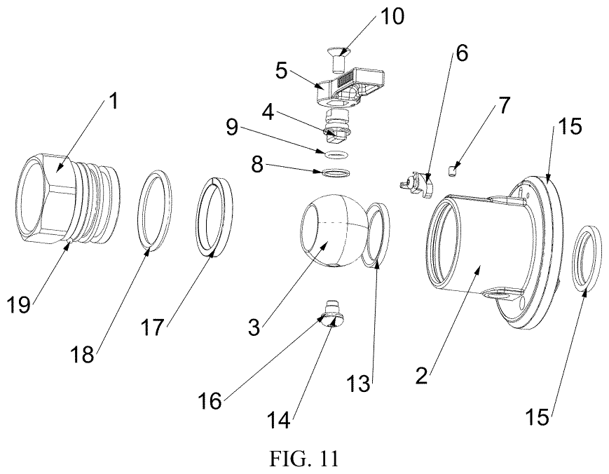

As shown in FIGS. 2 and 11, a left end and a right end of the tail portion 1 are open, and an interior of the tail portion 1 is hollow. A first end of the tail portion 1 away from the valve body 2 defines a threaded port (e.g., a standard pipe threaded port) configured to connect to pipelines of different specifications. A second end of the tail portion 1 is inserted into the valve body 2 and is rotatably connected to the valve body 2 through a steel ball 19 and a second guiding strap 17. Specifically, as shown in FIG. 2, three annular accommodating grooves are disposed on am outer wall of the tail portion 1 from left to right. A first accommodating groove is configured to accommodate the steel ball 19. A second accommodating groove is configured to accommodate a fifth sealing ring 18. The fifth sealing ring 18 realizes a seal between the tail portion 1 and the valve body 2. A third accommodating groove is configured to accommodate the second guiding strap 17. The second guiding strap 17 is configured to reduce rotational friction resistance between the tail portion 1 and the valve body 2. The steel ball 19, the fifth sealing ring 18, and the second guiding strap 17 are positioned between the tail portion 1 and the valve body 2.

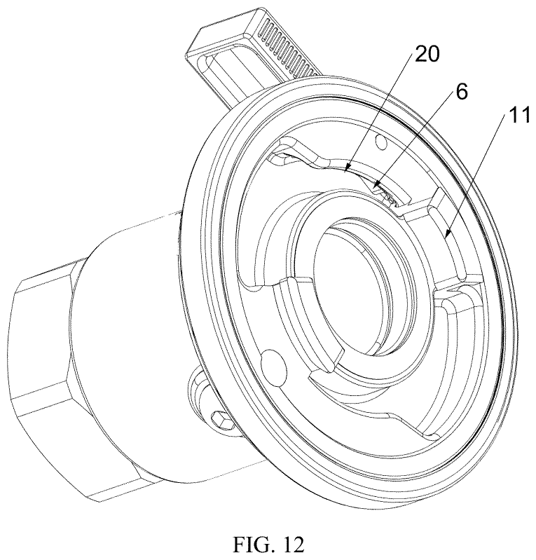

As shown in FIGS. 2 and 11, a left end and a right end of the valve body 2 are also open, and an interior of the valve body is hollow. The left end of the valve body is connected to the tail portion 1, and the right end of the valve body is configured to dock with another replaceable joint (i.e., an identical replaceable joint). A first valve body accommodating groove corresponding to the first accommodating groove is disposed on the tail portion 1. The steel ball 19 is sandwiched between the first valve body accommodating groove and the first accommodating groove of the tail portion 1, so that the tail portion is rotatably connected to the valve body. A hole is formed in the valve body 2. The hole is communicated with the first valve body accommodating groove. The steel ball 19 is embedded into the first valve body accommodating groove through the hole, and the hole is sealed with a fixing screw 7 to prevent the steel ball 19 from slipping out. Through holes are defined on a middle portion of the valve body 2, and the through holes are respectively on an upper side and a lower side of the valve body 2. The two through holes are communicated with an internal cavity of the valve body 2 and are configured to mount the rotating valve. A second valve body accommodating groove that is annular is defined on a left side of the internal cavity of the valve body 2. A third sealing ring 13 is embedded in the second valve body accommodating groove. The third sealing ring 13 is closely attached to a surface of the valve core 3 of the rotating valve, thus achieving a rotational seal between the valve core 3 and the valve body 2. A second sealing ring 12 is disposed on a mating end surface of the right end of the valve body 2. When two replaceable joints are docked (i.e., the replaceable joint is docked with the identical replaceable joint), the second sealing ring 12 contacts a second sealing ring of the identical replaceable joint, achieving radial sealing for the two replaceable joints. As shown in FIG. 12, two protrusions 11 and two grooves 20 are disposed on the mating end surface of the right end of the valve body 2. The number of protrusions 11 and grooves 20 may be increased or decreased according to actual requirements and is not limited thereto. When the two replaceable joints are docked together, the protrusions 11 of the replaceable joint are respectively rotatably engaged with the grooves 20 of the identical replaceable joint, and the grooves of the replaceable joint are respectively rotatably engaged with the protrusions of the identical replaceable joint, thereby achieving axial locking between the two replaceable joints. An outer wall at the mating end of the valve body 2 is sleeved by a protective sleeve 15 for protection.

As shown in FIGS. 2-4 and 11, the rotating valve comprises a fixing pin 14, a valve core 3, a valve rod 4, a handle 5, a first guiding strap 8, a first sealing ring 9, a first screw 10, and a fourth sealing ring 16.

The fixing pin 14 is fixedly connected to one of the through holes on the lower side of the valve body 2. One end of the fixing pin 14 extends into the valve body 2. The fourth sealing ring 16 is disposed on an end surface between the fixing pin 14 and the valve body 2, achieving a seal between the fixing pin 14 and the valve body 2. The valve core 3 is rotatably connected to the one end of the fixing pin 14 extending into the valve body. An opening is formed in a middle of the valve core 3. When the opening is aligned with the internal cavity of the valve body 2 (i.e., located in a straight line), the valve body 2 is in an open state, allowing fluid media to flow from one end of the valve core 3 to the other end of the valve core. A slot is formed on an upper portion of the valve core 3, and the slot is matched with a lower portion of the valve rod 4.

The valve rod 4 is rotatably mounted on one of the through holes on the upper side of the valve body 2. The lower portion of the valve rod 4 passes through one of the through holes on the upper side of the valve body 2 and is inserted into the slot of the valve core 3. The lower portion of the valve rod 4 is square-shaped. The valve rod 4 rotates to drive the valve core 3 to rotate. A first sealing ring 9 and a first guiding strap 8 are disposed between an outer wall of the valve rod 4 and the one of the through holes on the upper side of the valve body 2. The first sealing ring 9 is annular. The first sealing ring 9 achieves a seal between the valve rod 4 and the valve body 2, while the first guiding strap 8 is configured to reduce rotational friction between the valve rod 4 and the valve body 2. A middle-upper portion of the valve rod 4 defines a threaded hole. An upper portion of the valve rod 4 is square-shaped.

A recess matched with the upper portion of the valve rod 4 is defined on a lower portion of the handle 5. The upper portion of the valve rod 4 is inserted into the recess of the handle. The handle 5 further comprises a mounting hole configured to accommodate the first screw 10. The first screw 10 is threaded from the mounting hole into the threaded hole of the valve rod 4, so that the handle 5 is fixedly connected to the valve rod 4. The handle 5 is rotated to drive the valve rod 4 to rotate. As shown in FIG. 4, the handle 5 further comprise a sliding track. An axis of the sliding track coincides with a rotation axis of the handle 5. The sliding track comprises an inclined track 27 and a straight track 28.

As shown in FIGS. 2-4 and 11, the movable latch 6 is rotatably mounted in a corresponding one of the grooves 20 close to the handle 5, forming a lever structure. The rotating valve cooperates with the movable latch 6. When the rotating valve is in an open state, the movable latch 6 is engaged with the matched protrusion 11 in the corresponding one of the grooves 20, so as to limit a rotation of the matched protrusion in a circumferential direction. When the rotating valve is in a closed state, the movable latch 6 is disengaged from the matched protrusion 11. The movable latch 6 is fixedly connected in the corresponding one of grooves 20 through a second screw 22. In the embodiment, the movable latch 6 is fixedly connected in the corresponding one of the groove 20 close to the handle 5 by the second screw 22. The movable latch 6 is rotatably connected to the second screw 22. A locking hook 21 is formed on a first end of the movable latch 6, and a second end of the movable latch 6 is fixedly connected to a protruding pin 23. The protruding pin 23 is integrally formed with the movable latch 6. In an initial state, one end of the protruding pin 23 is positioned within the inclined track 27 of the handle 5.

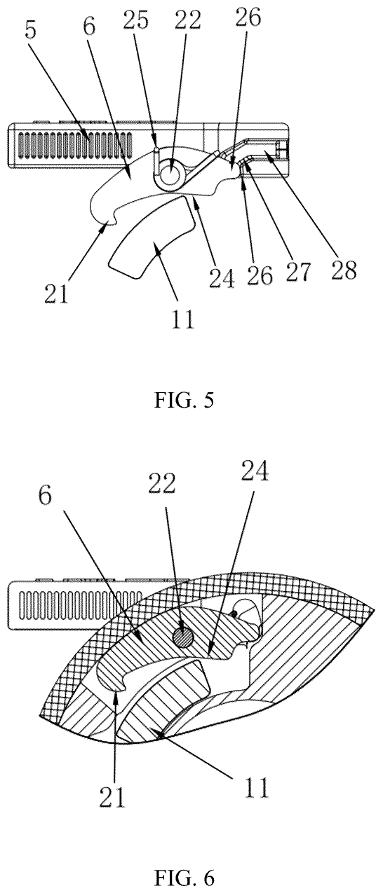

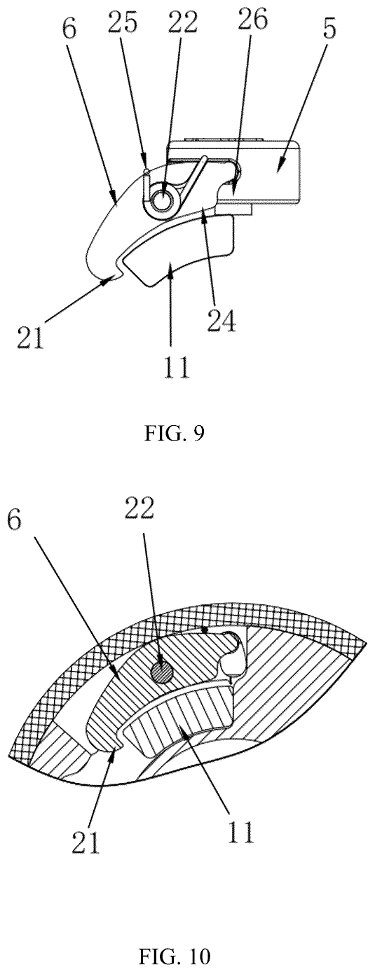

It is understandable that, as shown in FIGS. 5-10, after the two replaceable joints are docked with each other, an operator rotates the handle 5 to switch the rotating valve to the open state. The sliding track on the handle 5 rotates along with the handle 5. At this point, the inclined track 27 presses against the protruding pin 23, causing the protruding pin 23 to rotate upward and lift. Therefore, the protruding pin moves into the straight track 28. Simultaneously, the locking hook 21 rotates and moves downward. As shown in FIGS. 9 and 10, the locking hook 21 hooks the matched protrusion 11 of the identical replaceable joint, so that the movable latch 6 and the matched protrusion 11 form a circumferential engagement, preventing the two replaceable joints from accidentally coming loose and effectively limiting a circumferential rotational freedom of the two replaceable joints. When the handle 5 is rotated to close the rotating valve, the protruding pin 23 moves back into the inclined track 27. As the handle 5 continues to rotate, the inclined track 27 presses against the protruding pin 23, causing the protruding pin 23 to move toward a bottom portion of the inclined track 27. At this point, the locking hook 21 lifts upward and no longer hooks the matched protrusion 11, thereby releasing the engagement between the two replaceable joints.

In a second embodiment of the present disclosure, as shown in FIGS. 4-10, the replaceable joint further comprises a ramp 24 formed on the movable latch 6. The sliding track further comprises a blocking track 26. A torsion spring 25 is disposed between the movable latch 6 and the joint body.

Specifically, the ramp 24 presses against the matched protrusion 11 of the identical replaceable joint. The blocking track 26 is communicated with the inclined track 27, and the inclined track 27 is straight and inclined. In the initial state, the protruding pin 23 is positioned at the blocking track 26. When the matched protrusion 11 is screwed into the corresponding one of the groove 20, the matched protrusion 11 presses against the ramp 24, causing the protruding pin 23 to move to the inclined track 27.

It is noted that in the initial state, the protruding pin 23 is positioned in the blocking track 26. Due to an inclined vertical state of the blocking track 26, an interaction between the protruding pin 23 and the blocking track 26 prevents the handle 5 from rotating. When the two replaceable joints are docked, as the protrusions 11 of the replaceable joint screws into the grooves 20 of the identical replaceable joint, the matched protrusion 11 presses against the ramp 24, causing the ramp 24t to move upward. Since the ramp 24 is on the same end as the protruding pin 23, the protruding pin 23 also moves upward to the inclined track 27. At this point, the handle 5 is rotatable to open or close the rotating valve. In other words, when the two replaceable joints are not fully docked, the rotating valve is unable to be rotated. When the handle 5 is rotated to drive the valve core 3 to rotate and close (i.e., driving the rotating valve to close), the protruding pin 23l moves to a lowest end of the inclined track 27. When the matched protrusion 11 of the identical replaceable joint rotates out of the corresponding one of the grooves 20 and no longer presses against the ramp 24, under an action of the torsion spring 25, the protruding pin 23 moves downward into the blocking track 26 and resets to an original position.

In summary, when the two replaceable joints are locked by rotation and connected to each other, the protrusion 11 of the opposite replaceable joint rotates and presses against the ramp 24. The ramp 24 moves upward, while the protruding pin 23 also rotates upward and moves into the inclined track 27. Meanwhile, the locking hook 21 rotates downward. At this point, the locking hook 21 does not interfere with the circumferential rotation path of the matched protrusion 11 of the opposite replaceable joint, allowing the two replaceable joints to continue rotating and unscrewing in the circumferential direction. When the handle 5 rotates to drive the valve core 3 to rotate and open, the protruding pin 23 is pushed upward through the inclined track 27 and is pushed into the straight track 28. The locking hook 21 then hooks onto the matched protrusion 11 of the opposite replaceable joint, limiting the circumferential rotation of the opposite replaceable joint. The movable latch 6 of the replaceable joint forms a circumferential engagement with the matched protrusion 11 of the opposite replaceable joint, effectively limiting a circumferential rotation degree of freedom of the two replaceable joints, thereby preventing the two replaceable joints from loosening. Additionally, when the two replaceable joints are not engaged, the handle 5 is blocked by the blocking track 26 due to the protruding pin 23, preventing handle 5 from being rotated, and the valve core 3 remains in the closed state. When the two replaceable joints are rotated and locked together, the matched protrusion 11 of the opposite replaceable joint presses against the ramp 24, causing the protruding pin 23 to move from the blocking track 26 to the inclined track 27. At this point, the valve core 3 is rotated and opened by the handle 5. Therefore, the valve core 3 is only allowed to be opened after the two replaceable joints are connected to each other, achieving the anti-misoperation function.

In the description of the present disclosure, the description of reference terms “one embodiment”, “some embodiments”, “examples”, “particular examples”, “some examples”, etc. mean that particular features, structures, materials, or characteristics described in connection with the embodiments or examples are comprised in at least one embodiment or example of the present disclosure. In the specification, schematic representations of the above terms do not necessarily refer to the same embodiment or example. Furthermore, the specific features, structures, materials or characteristics described may be combined in any suitable manner in any one or more embodiments or examples.

The above-mentioned embodiments only represent some embodiments of the present disclosure. The descriptions thereof are specific and detailed, but should not be construed as a limitation of the scope of the present disclosure. It should be pointed out that for those of ordinary skill in the art, without departing from the concept of the present disclosure, modifications and improvements can be made. The modifications and the improvements belong to the protection scope of the present disclosure. Therefore, the protection scope of the present disclosure should be subject to the attached claims.

What is claimed is:

1. A replaceable joint with a bidirectional interlocking function, comprising:
a joint body;
a rotating valve; and
a movable latch;
wherein protrusions and grooves are disposed on a docking end of the joint body, when the replaceable joint is docked with an identical replaceable joint, the protrusions of the replaceable joint are respectively screwed into grooves of the identical replaceable joint, and the grooves of the replaceable joint are respectively engaged with protrusions of the identical replaceable joint, so that the replaceable joint is locked with the identical replaceable joint;
wherein the rotating valve is disposed on the joint body, a handle of the rotating valve is disposed on an outer side of the joint body, and the handle is rotated to close or open the rotating valve;
wherein the movable latch is rotatably disposed in one of the grooves close to the rotating valve to form a lever structure, and the rotating valve is matched with the movable latch;
wherein when the rotating valve is in an open state, the movable latch is disposed in the one of the grooves and is engaged with a matched protrusion of the protrusions of the identical replaceable joint to limit a rotation of the matched protrusion in a circumferential direction, and when the rotating valve is in a closed state, the movable latch is disengaged with the matched protrusion;
wherein a lock hook is disposed on a first end of the movable latch, a protruding pin is disposed on a second end of the movable latch, and a middle portion of the movable latch is rotatably connected to the joint body;
wherein a sliding track is disposed on the handle of the rotating valve, and the sliding track comprises an inclined track and a straight track;
wherein in an initial state, the protruding pin is positioned at the inclined track, and when the handle is rotated to open the rotating valve, the protruding pin is pressed by the inclined track to cause the locking hook of the movable latch to engage with the protruding block;
wherein the movable latch further comprises a ramp, and the ramp is in press fit with the matched protrusion, the sliding track further comprises a blocking track, the blocking track is communicated with the inclined track, the inclined track is straight and inclined, and in the initial state, the protruding pin is positioned at the blocking track;
wherein when the matched protrusion of the identical replaceable joint is screwed into a corresponding one of the grooves of the replaceable joint, the matched protrusion pushes the inclined track to move the protruding pin to the inclined track; and the replaceable joint further comprises a torsion spring disposed between the movable latch and the joint body.

2. The replaceable joint according to claim 1, wherein the joint body comprises a valve body, a tail portion rotatably connected to the valve body;
wherein a threaded port configured to connect to a pipeline is disposed on the tail portion, the rotating valve and the movable latch are disposed on the valve body, and the protrusions and the groove are disposed on one side of the valve body away from the tail portion.

3. The replaceable joint according to claim 2, wherein a steel ball is disposed between the tail portion and the valve body, and the valve body is rotatably connected to the tail portion through the steel ball.

4. The replaceable joint according to claim 3, wherein a fifth sealing ring and a second guiding strap are further provided between the tail portion and the valve body.

5. The replaceable joint according to claim 2, wherein the rotating valve comprises a valve core rotatably disposed inside the joint body, the handle is fixedly connected to the valve core, and the valve core is controlled by rotating the handle to close or open the pipeline.

6. The replaceable joint according to claim 5, wherein the handle and the valve core are fixedly connected by a valve rod; a first sealing ring is disposed between an outer wall of the valve rod and the valve body, and a first guiding strap is disposed between the outer wall of the valve rod and the valve body;
wherein the rotating valve further comprises a fixing pin disposed on the valve body, the valve core is rotatably connected to the fixing pin, and a fourth sealing ring is provided between the fixing pin and the valve body.

7. The replaceable joint according to claim 1, wherein a second sealing ring is disposed on the docking end of the joint body, and when the replaceable joint is docked with the identical replaceable joint, the second sealing ring of the replaceable joint and a second sealing ring of the identical replaceable joint are pressed against and attached to each other.

8. The replaceable joint according to claim 5, wherein a third sealing ring is disposed on the valve body, and the third sealing ring is attached to a surface of the valve core.
